(19) United States
(12) Patent Application Publication
(10) Pub. No.: US 2018/0327297 A1
(43) Pub. Date: Nov. 15, 2018

(54) GLASS MANUFACTURING METHOD FOR REDUCED PARTICLE ADHESION

(71) Applicant: Corning Incorporated, Corning, NY (US)

(72) Inventors: Louis Joseph Stempin, Jr., Corning, NY (US); Wanda Janina Walczak, Big Flats, NY (US); Naiyue Zhou, Painted Post, NY (US)

(21) Appl. No.: 15/773,727

(22) PCT Filed: Nov. 4, 2016
(86) PCT No.: PCT/US2016/060514

§ 371 Date: May 4, 2018

Related U.S. Application Data
(60) Provisional application No. 62/251,219, filed on Nov. 5, 2015.

(51) Int. Cl. C03B 17/06; C03B 33/02; C03B 33/037; C03B 33/10; C03B 40/04

(52) U.S. Cl. CPC C03B 17/064; C03B 17/067; C03B 40/04; C03B 33/037; C03B 33/105; C03B 33/0215

(57) ABSTRACT

A method for producing a glass article includes forming a glass sheet from a molten glass source and separating the glass article from the glass sheet. During the step of separating the glass article from the glass sheet, the water content of the atmosphere surrounding the glass sheet is controlled to be below a predetermined value. Such control of the water content of the atmosphere surrounding the glass article can effectively reduce the density of particles adhered thereto.

This application claims the benefit of priority under 35 U.S.C. § 119 of U.S. Provisional Application Ser. No. 62/251,219 filed on Nov. 5, 2015, the content of which is relied upon and incorporated herein by reference in its entirety.

### BACKGROUND

### Field

The present disclosure relates generally to glass manufacturing methods and more specifically to methods of manufacturing glass articles with reduced particle adhesion.

### Technical Background

In the manufacture of glass materials, such as flat glass substrates for display applications, for example LCD televisions and handheld electronic devices, there is a continual desire to increase surface quality characteristics of the glass, especially as the image resolution for such applications continues to increase. Such surface quality characteristics can be affected by a number of factors including density of particles adhered to the surface. Such particles can be introduced to the surface as a result of various processing conditions, including processing steps wherein glass panels are separated from a larger glass substrate, for example a glass ribbon.

Most efforts to reduce the density of adhered particles on glass surfaces have focused on late stage processing steps, such as washing glass sheets via mechanical processing steps (e.g., brushes, rollers, sponges, etc.) and/or chemical processing steps (e.g., application of acidic or basic detergents, etc.). In that regard, while some efforts have been made to reduce the density of adhered particles in earlier processing steps, such efforts have often involved adhering a protective material or coating to the glass sheet. Such processing steps can, however, result in other surface quality defects, such as staining, and, in any event, typically require additional steps to both apply and remove the protective material or coating.

### SUMMARY

Disclosed herein is a method for producing a glass article. The method includes forming a glass sheet, for example a glass ribbon, from a molten glass source. The method also includes separating the glass article from the glass sheet. During the step of separating the glass article from the glass sheet, the water content of the atmosphere surrounding the glass sheet is controlled to be below a predetermined value.

Additional features and advantages of these and other embodiments will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments of the present disclosure, and are intended to provide an overview or framework for understanding the nature and character of the embodiments as claimed. The accompanying drawings are included to provide a further understanding of these and other embodiments, and are incorporated into and constitute a part of this specification. The drawings illustrate various embodiments of these and other embodiments, and together with the description serve to explain the principles and operations thereof.

### BRIEF DESCRIPTION OF THE DRAWINGS

FIG. 1 is a schematic view of an apparatus for producing a glass article including a forming device in accordance with aspects of the disclosure;

FIG. 2 is a cross-sectional enlarged perspective view of the forming device of FIG. 1; and

FIG. 3 is a chart showing particle removal efficiency data for various different gas stream treatments.

### DETAILED DESCRIPTION

Reference will now be made to embodiments of the present disclosure, examples of which are illustrated in the accompanying drawings. Whenever possible, the same reference numerals will be used throughout the drawings to refer to the same or like parts.

As used herein, the term “working point” refers to the temperature in degrees Celsius at which the viscosity of the glass is 10⁴ poise.

As used herein, the term “softening point” refers to the temperature in degrees Celsius at which the viscosity of the glass is 10^{7.6} poise.

As used herein, the term “annealing point” refers to the temperature in degrees Celsius at which the viscosity of the glass is 10¹³ poise.

As used herein, the term “strain point” refers to the temperature in degrees Celsius at which the viscosity of the glass is 10^{14.5} poise.

As used herein, the term “substantially free of water” refers to an atmosphere having a water content of less than about 0.01 wt %, based on the total weight of the atmosphere.

As used herein, the term “density of particles adhered to the glass article” refers to the number of observed particles within a given surface area of a glass article, as can be determined by, for example, measuring the average number of particles having a diameter of greater than a given size (e.g., one micrometer diameter) observed in a one centimeter square area of the surface of the glass article.

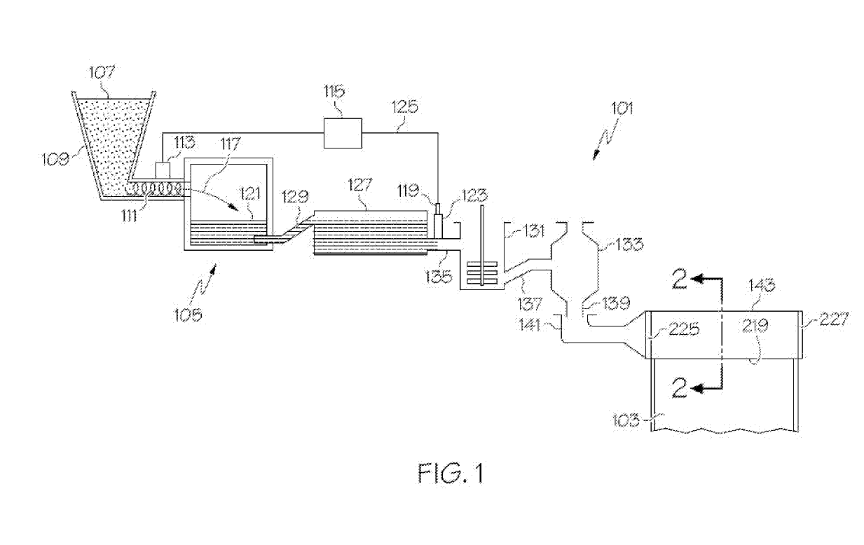

FIG. 1 illustrates an exemplary schematic view of a glass forming apparatus 101 for fusion drawing a glass ribbon 103 for subsequent processing into glass sheets. The illustrated glass forming apparatus comprises a fusion draw apparatus although other fusion forming apparatus may be provided in further examples. The glass forming apparatus 101 can include a melting vessel (or melting furnace) 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by an arrow 117. A glass level probe 119 can be used to measure a glass melt (or molten glass) 121 level within a standpipe 123 and communicate the measured information to the controller 115 by way of a communication line 125.

The glass forming apparatus 101 can also include a fining vessel 127, such as a fining tube, located downstream from the melting vessel 105 and fluidly coupled to the melting vessel 105 by way of a first connecting tube 129. A mixing vessel 131, such as a stir chamber, can also be located downstream from the fining vessel 127 and a delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver glass melt 121 from the delivery vessel 133 to an inlet 141 of a forming device 143. As shown, the melting vessel 105, fining vessel 127, mixing vessel 131, delivery vessel 133, and forming device 143 are examples of glass melt stations that may be located in series along the glass forming apparatus 101.

The melting vessel 105 is typically made from a refractory material, such as refractory (e.g., ceramic) brick. The glass forming apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide. The platinum-containing components can include one or more of the first connecting tube 129, the fining vessel 127 (e.g., finer tube), the second connecting tube 135, the standpipe 123, the mixing vessel 131 (e.g., a stir chamber), the third connecting tube 137, the delivery vessel 133 (e.g., a bowl), the downcomer 139 and the inlet 141. The forming device 143 is made from a ceramic material, such as the refractory, and is designed to form the glass ribbon 103.

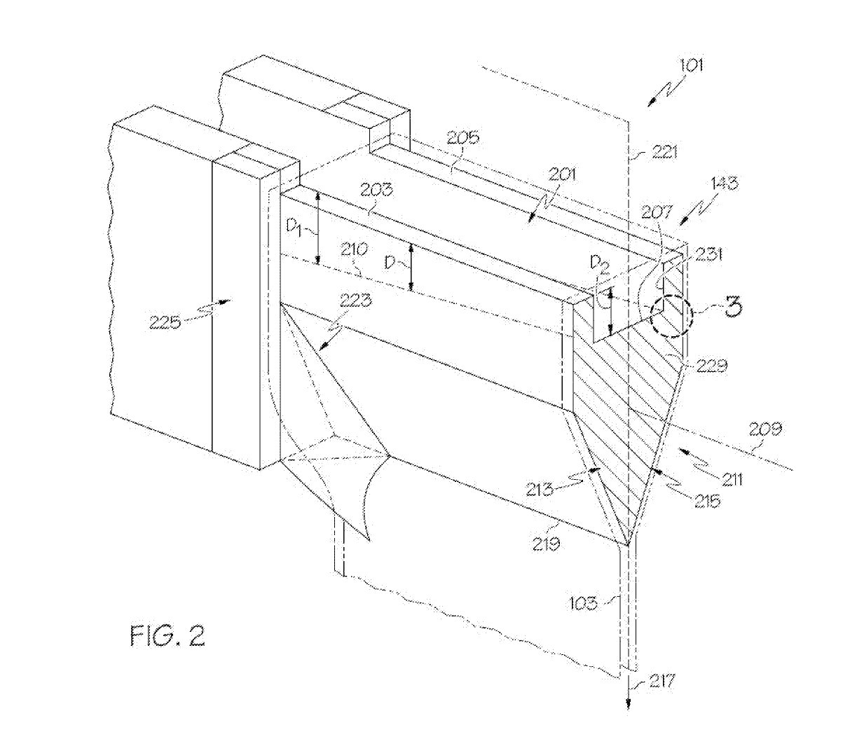

FIG. 2 is a cross-sectional perspective view of the glass forming apparatus 101 along line 2-2 of FIG. 1. As shown, the forming device 143 can include a trough 201 at least partially defined by a pair of weirs comprising a first weir 203 and a second weir 205 defining opposite sides of the trough 201. As further shown, the trough 201 may also be at least partially defined by a bottom wall 207. As shown, the inner surfaces of the weirs 203, 205 and the bottom wall 207 define a substantially U shape that may be provided with round corners. In further examples, the U shape may have surfaces substantially 90° relative to one another. In still further examples, the trough may have a bottom surface defined by an intersection of the inner surfaces of the weirs 203, 205. For example, the trough may have a V-shaped profile. Although not shown, the trough can include further configurations in additional examples.

As shown, the trough 201 can have a depth “D” between a top of the weir and a lower portion of the trough 201 that varies along an axis 209, although the depth may be substantially the same along the axis 209. Varying the depth “D” of the trough 201 may facilitate consistency in glass ribbon thickness across the width of the glass ribbon 103. In just one example, as shown in FIG. 2, the depth “D₁” near the inlet of the forming device 143 can be greater than the depth “D₂” of the trough 201 at a location downstream from the inlet of the trough 201. As demonstrated by the dashed line 210, the bottom wall 207 may extend at an acute angle relative to the axis 209 to provide a substantially continuous reduction in depth along a length of the forming device 143 from the inlet end to the opposite end.

The forming device 143 further includes a forming wedge 211 comprising a pair of downwardly inclined forming surface portions 213, 215 extending between opposed ends of the forming wedge 211. The pair of downwardly inclined forming surface portions 213, 215 converge along a downstream direction 217 to form a root 219. A draw plane 221 extends through the root 219 wherein the glass ribbon 103 may be drawn in the downstream direction 217 along the draw plane 221. As shown, the draw plane 221 can bisect the root 219, although the draw plane 221 may extend at other orientations with respect to the root 219.

The forming device 143 may optionally be provided with one or more edge directors 223 intersecting with at least one of the pair of downwardly inclined forming surface portions 213, 215. In further examples, the one or more edge directors can intersect with both downwardly inclined forming surface portions 213, 215. In further examples, an edge director can be positioned at each of the opposed ends of the forming wedge 211 wherein an edge of the glass ribbon 103 is formed by molten glass flowing off the edge director. For instance, as shown in FIG. 2, the edge director 223 can be positioned at a first opposed end 225 and a second identical edge director (not shown in FIG. 2) can be positioned at a second opposed end (see 227 in FIG. 1). Each edge director 223 can be configured to intersect with both of the downwardly inclined forming surface portions 213, 215. Each edge director 223 can be substantially identical to one another although the edge directors may have different characteristics in further examples. Various forming wedge and edge director configurations may be used in accordance with aspects of the present disclosure. For example, aspects of the present disclosure may be used with forming wedges and edge director configurations disclosed in U.S. Pat. No. 3,451,798, U.S. Pat. No. 3,537,834, U.S. Pat. No. 7,409,839 and/or U.S. Provisional Pat. Application No. 61/155,669, filed Feb. 26, 2009, which are each herein incorporated by reference in their entirety.

While the above description relates to a fusion apparatus and process for forming a glass sheet from a molten glass source, it is to be understood that embodiments disclosed herein also include other processes for forming glass sheets from a molten glass source, such as float processes and slot draw processes.

Upon formation of a glass sheet from a molten glass source, the glass sheet may be separated into glass articles, such as glass panes, using at least one of any number of techniques known to persons having skill in the art for separating glass articles from the glass sheet.

For example, in embodiments where the glass sheet is moving (e.g., a moving glass ribbon) as it is being separated into glass articles, such as glass panes, the separation apparatus may first include a scoring assembly to impart a score line along an intended separation path between glass articles, such as a mechanical scoring assembly of the moving scribe/moving anvil type and/or a laser based scoring assembly. The separation apparatus may also include an engagement assembly for releasably engaging the moving sheet. In addition, the separation apparatus may include a transporter adapted to bring the pane engaging assembly into engagement with the moving sheet and to rotate that assembly about an axis which substantially coincides with the score line. The separation apparatus may further include a connector assembly for connecting the pane engaging assembly and the transporter so that the pane engaging assembly moves relative to the transporter upon separation of the pane from the moving sheet so that the pane and the sheet do not contact each other once separation occurs. Application of the separation apparatus may include releasably engaging the moving sheet, rotating the to-be-separated pane about an axis which substantially coincides with the score line, the rotation causing the pane to separate from the sheet, and moving the separated pane relative to the moving sheet either passively using gravity as the motive force, and/or actively using, for example, at least one of a hydraulic force, a mechanical spring force, a pneumatic force, and a vacuum so that the pane and the sheet do no contact each other once separation occurs. Such separation apparatuses and processed are disclosed, for example, in U.S. Pat. No. 6,616,025, which is incorporated herein by reference in its entirety.

During separation of glass articles, such as glass panes, from the glass sheet, small glass particles can be generated as a result of the separation of the brittle material. Small glass particles may also be inherently present in the atmosphere surrounding the glass sheet. Such particles can easily adhere to the surface of the glass sheet, particularly at glass sheet temperatures above 100° C., such as glass sheet temperatures of from about 100° C. to about 500° C., including glass sheet temperatures from about 200° C. to about 400° C.

Efforts to remove adhered glass particles can include downstream processing steps involving, for example, utilization of mechanical and/or chemical techniques. Mechanical techniques can include, for example, application of at least one of brushes, rollers, sponges, ultrasonics, and megasonics to at least one surface area of the glass. Chemical techniques can include, for example, applying at least one washing solution, slurry, or suspension, to at least one surface area of the glass. Such application may, for example, occur through at least one of spraying, dipping, brushing, and rolling.

Washing solutions can include, for example, water, including deionized water, aqueous solutions containing at least one of cationic surfactants, anionic surfactants, acidic components, basic components, detergents, and chelators. Detergents may include, for example, alkaline detergents and the like. Application of washing solutions may include multistep processes involving application of solutions having differing chemistries, such as application of at least one acidic solution in a separate processing step from application of at least one basic solution. Examples of such multistep processing techniques are disclosed in U.S. patent application no. 2014/0318578, which is incorporated herein by reference in its entirety.

While for many applications such processing steps have been found to be effective in reducing the density of particles adhered to a glass article, such as a glass pane (i.e., the density of particles adhered to the glass article subsequent to such processing steps as compared to the density of particles adhered to the glass article prior to such processing steps), processes enabling lower density of particles adhered to the glass article may still be needed for certain applications (such as display applications in which increasingly high image resolution is desired).

In response to this issue, processes disclosed herein can enable the density of particles adhered to a glass article to be reduced to a level that meets or exceeds requirements for applications in which increasingly low particle density is desired. For example, certain exemplary embodiments disclosed herein can enable particle densities of less than 0.001 particles having a diameter greater than one micron per square centimeter of surface area. Certain exemplary embodiments disclosed herein can also enable particle densities less than 0.01 particles having a diameter of greater than 0.3 microns per square centimeter of surface area. Such processes have been found to be particularly effective when combined with, for example, at least one of the downstream processing steps (e.g., mechanical and/or chemical processing steps) described herein.

In this regard, applicants have surprisingly discovered that reduced particle densities can be achieved by controlling the water content of the atmosphere surrounding the glass sheet to be below a predetermined value during the step of separating the glass article from the glass sheet. For example, applicants have discovered that reduced particle densities can be achieved when, during the step of separating the glass article from the glass sheet, the atmosphere surrounding the glass sheet is in a relatively dry state wherein the water content of the atmosphere is significantly below the water saturation level at a given temperature. When the water content of the atmosphere surrounding the glass sheet is controlled in such a manner, the adherence of particles to the glass sheet is reduced, such as glass particles generated as a result of the separation process as well as other particles inherently present in the atmosphere surrounding the glass sheet.

As the temperature of the glass sheet during the separation process is often above 100° C., such as from about 100° C. to about 500° C., the temperature of the atmosphere surrounding the glass sheet is typically elevated, such as at least about 35° C., and further such as at least about 50° C., and yet further such as at least about 65° C., and still yet further such as at least about 100° C., including from about 35° C. to about 200° C., such as from about 50° C. to about 150° C. Embodiments disclosed herein include those in which, during the step of separating the glass article from the glass sheet under these temperature conditions, the water content of the atmosphere surrounding the glass sheet is controlled to be less than 1 wt % based on the total weight of the atmosphere, such as less than about 0.5 wt % based on the total weight of the atmosphere, and further such as less than about 0.2 wt % based on the total weight of the atmosphere, and yet further such as less than about 0.1 wt % based on the total weight of the atmosphere, and still yet further such as less than about 0.05 wt % based on the total weight of the atmosphere, including from about 0.01 wt % to about 1 wt % based on the total weight of the atmosphere, further including from about 0.05 wt % to about 0.5 wt % based on the total weight of the atmosphere, and yet further including from about 0.1 wt % to about 0.2 wt % based on the total weight of the atmosphere.

Embodiments disclosed herein also include those in which, during the step of separating the glass article from the glass sheet, the water content of the atmosphere surrounding the glass sheet is controlled to be from about 0.01 wt % to about 0.1 wt % based on the total weight of the atmosphere, such as from about 0.02 wt % to about 0.08 wt % based on the total weight of the atmosphere. Embodiments disclosed herein also include those in which, during the step of separating the glass article from the glass sheet, the atmosphere surrounding the glass sheet is controlled to be substantially free of water.

By way of further example, embodiments disclosed herein include those in which, during the step of separating the glass article from the glass sheet, the temperature of the atmosphere surrounding the glass sheet is at least about 35° C., such as from about 35° C. to about 200° C., and the water content of the atmosphere surrounding the glass sheet is controlled to be less than about 1 wt %, such as less than about 0.5 wt %, and further such as less than about 0.1 wt %, and yet further such as less than about 0.05 wt % based on the total weight of the atmosphere.

Embodiments disclosed herein also include those in which, during the step of separating the glass article from the glass sheet, the temperature of the atmosphere surrounding the glass sheet is at least about 50° C., such as from about 50° C. to about 200° C., and the water content of the atmosphere surrounding the glass sheet is controlled to be less than about 1 wt %, such as less than about 0.5 wt %, and further such as less than about 0.1 wt %, and yet further such as less than about 0.05 wt % based on the total weight of the atmosphere.

Embodiments disclosed herein also include those in which, during the step of separating the glass article from the glass sheet, the temperature of the atmosphere surrounding the glass sheet is at least about 65° C., such as from about 65° C. to about 200° C., and the water content of the atmosphere surrounding the glass sheet is controlled to be less than about 1 wt %, such as less than about 0.5 wt %, and further such as less than about 0.1 wt %, and yet further such as less than about 0.05 wt % based on the total weight of the atmosphere.

Embodiments disclosed herein also include those in which the water content of the atmosphere surrounding the glass sheet is controlled not only during the step of separating the glass article from the glass sheet but also prior to the step of separating the glass article from the glass sheet, such as where the water content of the atmosphere surrounding the glass sheet is controlled to be below a predetermined value from a time of at least 1 minute, such as at least 30 seconds, and further such as at least 10 seconds, including from 10 seconds to about 10 minutes prior to the step of separating the glass article from the glass sheet up to and including the time of separating the glass article from the glass sheet.

Embodiments disclosed herein also include those in which the water content of the atmosphere surrounding the glass sheet is controlled when the temperature of the glass sheet is elevated relative to the temperature of the glass sheet during the step of separating the glass article from the glass sheet. For example, embodiments disclosed herein include those in which the water content of the atmosphere surrounding the glass sheet is controlled to be below a predetermined value when the temperature of the glass sheet is in a range between the temperature of the glass sheet during the step of separating the glass article from the glass sheet and a temperature of up to about 1,000° C. higher, such as up to about 500° C. higher, and further such as up to about 200° C. higher, and still yet further such as up to about 100° C. higher than the temperature of the glass sheet during the step of separating the glass article from the glass sheet.

In certain exemplary embodiments, the water content of the atmosphere surrounding the glass sheet may be controlled during part or all of the cooling and formation of the glass sheet from a molten glass source up to and including the step of separating the glass article from the glass sheet. For example, in certain exemplary embodiments, the water content of the atmosphere surrounding the glass sheet may be controlled to be below a predetermined value during at least the stage between when the glass sheet is at its strain point up to and including the step of separating the glass article from the glass sheet. In certain exemplary embodiments, the water content of the atmosphere surrounding the glass sheet may be controlled to be below a predetermined value during at least the stage between when the glass sheet is at its annealing point up to and including the step of separating the glass article from the glass sheet. In certain exemplary embodiments, the water content of the atmosphere surrounding the glass sheet may be controlled to be below a predetermined value during at least the stage between when the glass sheet is at its softening point up to and including the step of separating the glass article from the glass sheet. In certain exemplary embodiments, the water content of the atmosphere surrounding the glass sheet may be controlled to be below a predetermined value during at least the stage between when the glass sheet is at its working point up to and including the step of separating the glass article from the glass sheet.

In certain exemplary embodiments, the water content of the atmosphere surrounding the glass sheet may be controlled subsequent to the step of separating the glass article from the glass sheet, such as where the water content of the atmosphere surrounding the glass sheet is controlled to be below a predetermined value from a time of at least about 1 minute, such as at least 30 seconds, and further such as at least 10 seconds, including from 10 seconds to about 10 minutes subsequent to the step of separating the glass article from the glass sheet back to and including the time of separating the glass article from the glass sheet.

Controlling the water content of the atmosphere surrounding the glass sheet can be achieved by at least one of a variety of methods. For example, in some embodiments, during the step of separating the glass article from the glass sheet, a gas stream can be flowed over the glass sheet, wherein the gas stream has a water content that is controlled to be below a predetermined level. Such embodiments may include, for example, those in which at least 99 wt % of the gas stream comprises at least one gas selected from the group consisting of nitrogen, oxygen, and argon. Such embodiments can also include those in which the gas stream consists essentially of at least one gas selected from the group consisting of nitrogen, oxygen, and argon. Such embodiments may include those in which the temperature of the gas stream is at least about 35° C., such as from about 35° C. to about 200° C., and further such as from 50° C. to 150° C. Such gas stream may, for example, comprise less than about 0.1 wt % water, such as less than about 0.05 wt % water, and further such as less than about 0.02 wt % water, and even further such as less than about 0.01 wt % water.

Embodiments in which at least about 99 wt % of the gas stream comprises at least one gas selected from the group consisting of nitrogen, oxygen, and argon include those in which the gas stream comprises both nitrogen and oxygen, including those in which the weight ratio of nitrogen to oxygen in the gas stream ranges from 4:1 to 8:1 and further including those in which the temperature of the gas stream is at least about 35° C., such as from about 35° C. to about 200° C., and further such as from about 50° C. to about 150° C. Such gas stream may, for example, comprise less than about 0.1 wt % water, such as less than about 0.05 wt % water, and further such as less than about 0.02 wt % water, and even further such as less than about 0.01 wt % water.

Embodiments in which the gas stream consists essentially of at least one gas selected from the group consisting of nitrogen, oxygen, and argon include those in which the gas stream consists essentially of nitrogen and oxygen, including those in which the weight ratio of nitrogen to oxygen in the gas stream ranges from 4:1 to 8:1 and further including those in which the temperature of the gas stream is at least about 35° C., such as from about 35° C. to about 200° C., and further such as from about 50° C. to about 150° C. Such gas stream may, for example, comprise less than about 0.1 wt % water, such as less than about 0.05 wt % water, and further such as less than about 0.02 wt % water, and even further such as less than about 0.01 wt % water.

Embodiments in which at least about 99 wt % of the gas stream comprises at least one gas selected from the group consisting of nitrogen, oxygen, and argon include those in which at least about 99 wt % of the gas stream comprises nitrogen. Such embodiments also include those in which at least about 99 wt % of the gas stream comprises argon. In such embodiments the temperature of the gas stream, while not limited, may, for example, be at least about 35° C., such as from about 35° C. to about 200° C., and further such as from about 50° C. to about 150° C. Such gas stream may, for example, comprise less than about 0.1 wt % water, such as less than about 0.05 wt % water, and further such as less than about 0.02 wt % water, and even further such as less than about 0.01 wt % water.

Embodiments in which the gas stream consists essentially of at least one gas selected from the group consisting of nitrogen, oxygen, and argon include those in which the gas stream consists essentially of nitrogen. Such embodiments also include those in which the gas stream consists essentially of argon. In such embodiments the temperature of the gas stream, while not limited, may, for example, be at least about 35° C., such as from about 35° C. to about 200° C., and further such as from about 50° C. to about 150° C. Such gas stream may, for example, comprise less than about 0.1 wt % water, such as less than about 0.05 wt % water, and further such as less than about 0.02 wt % water, and even further such as less than about 0.01 wt % water.

The flow rate, composition, and temperature of the gas stream can be controlled such that, during the step of separating the glass article from the glass sheet, the water content of the atmosphere surrounding the glass sheet is controlled to be below the predetermined value. The flow rate, composition, and temperature of the gas stream can also be controlled such that the cooling rate of the glass sheet can follow a predetermined cooling curve, as can be determined by persons having ordinary skill in the art.

Once glass articles, such as glass panes, have been separated from the glass sheet in accordance with embodiments disclosed herein, the articles may be washed using, for example, any of the mechanical and/or chemical washing steps disclosed herein. For example, in certain exemplary embodiments, water and/or at least one detergent solution may be applied to the glass article. Such embodiments include those in which, following application of the detergent solution to the glass article, the density of particles adhered to the glass article is at least about 50%, such as at least about 60%, and further such as at least about 70%, and still yet further such as at least about 80% less than the density of particles adhered to the glass article in a process that does not comprise controlling the water content of the atmosphere surrounding the glass sheet to be below a predetermined value during the step of separating the glass article from the glass sheet.

Such embodiments can also include those in which, following application of the water and/or detergent solution to the glass article, the particle density of particles having a diameter of greater than about 1 micrometer, such as particle densities of from about 1 to about 400 micrometers, is less than about 0.001 particles per square centimeter, such as less than about 0.0005 particles per square centimeter, and further such as less than about 0.0002 particles per square centimeter.

Such embodiments can also include those in which, following application of the detergent solution to the glass article, the particle density of particles having a diameter of greater than about 0.3 micrometers, such as particle densities of about 0.3 micrometers to 400 micrometers, is less than about 0.01 particles per square centimeter, such as less than about 0.005 particles per square centimeter, and further such as less than about 0.002 particles per square centimeter.

### Examples

Embodiments herein are further illustrated in view of the following non-limiting examples.

Eagle XG® glass, available from Corning Incorporated, was cut into approximately two inch by two inch samples, washed with Crestline, which is a cleaning solution available from Crest Ultrasonics, rinsed with deionized water, and air dried. Particles having sizes of from about 0.8 microns to about 40 microns using a strobe light that captures light diffraction of contaminants present on the surface of the glass and glass samples with a particle count of no more than about 2 to 10 particles per square centimeter was chosen for subsequent work. The glass was then heated from about 25° C. to about 600° C. in a tube furnace at a rate of about 5° C. per minute, followed by cooling to about 400° C. at a rate of about 5° C. per minute, during which time one of the gas streams set forth in Table 1 below was flowed continuously over the glass. While the glass was maintained at a temperature of about 400° C., and with one of the gas streams as set forth in Table 1 being flowed continuously over the glass, Eagle XG® glass particles having diameters ranging from about 38 micrometers to up to about 106 micrometers were introduced to the glass surface. In a case of where the gas stream included an addition of water vapor, the gas stream was passed through a bubbler to pick up water before entrance into the tube furnace where the glass resided and where the glass particle introduction took place. Following cooling of the glass to about 25° C., the number of particles per square centimeter on the glass surface were counted using the strobe light, the glass washed with Crestline, and then the particles counted again. Particle removal efficiency was calculated by comparing the difference in counted particles before and after washing.

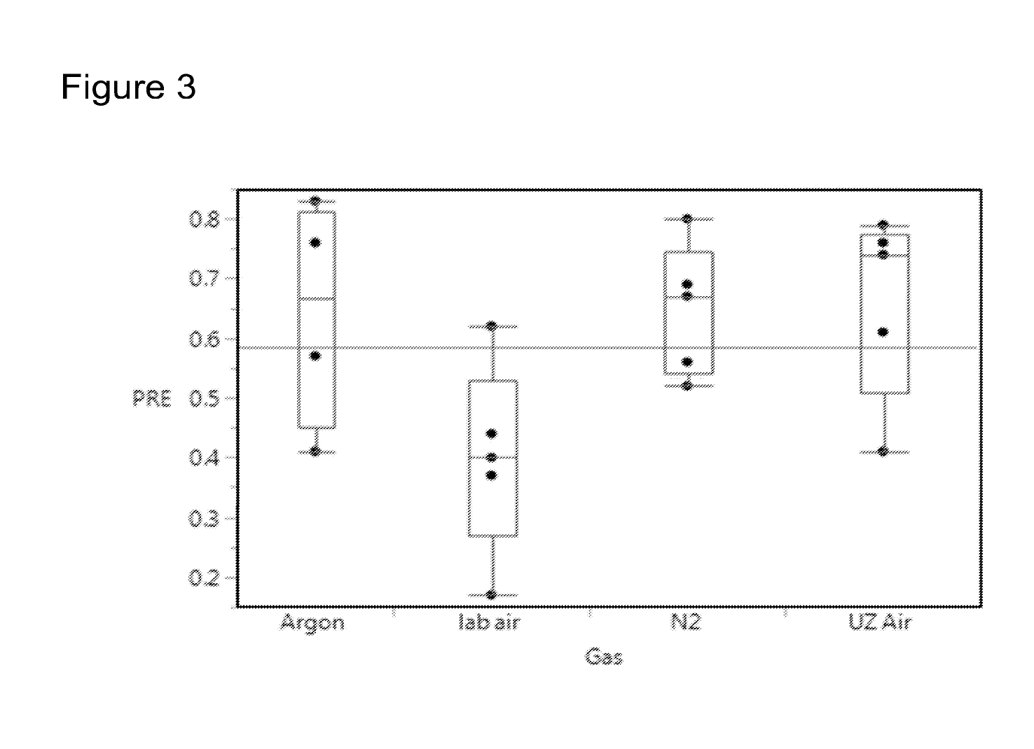

Table 1 shows a median particle removal efficiency (PRE) for a number of different gas streams, including substantially pure argon, substantially pure nitrogen (N₂), laboratory air (lab air), and a gas stream containing about 80 mol % nitrogen and 20 mol % oxygen (UZ Air). The substantially pure argon, substantially pure nitrogen, and UZ Air streams each had water contents of less than about 0.1 wt % based on the total weight of the stream. The laboratory air stream had a water content of about 2.9 wt % based on the total weight of the stream. FIG. 3 shows particle removal efficiency data for the various different gas streams indicated in Table 1. As can be seen, minimizing the water content of the gas stream during introduction of glass particles to the glass surface results in improved particle removal efficiency.

TABLE 1

| Gas stream composition | Median particle removal efficiency |
|---|---|
| Argon | 0.665 (66.5%) |
| Laboratory air (lab air) | 0.4 (40%) |
| Nitrogen (N₂) | 0.67 (67%) |
| 80/20 Nitrogen/oxygen mix (UZ air) | 0.74 (74%) |

While specific embodiments disclosed herein have been described with respect to an overflow downdraw process, it is to be understood that the principle of operation of such embodiments may also be applied to other glass forming processes such as flow processes and slot draw processes.

It will be apparent to those skilled in the art that various modifications and variations can be made to the embodiments of the present disclosure without departing from the spirit and scope of the disclosure. Thus, it is intended that the present disclosure cover the modifications and variations of these and other embodiments provided they come within the scope of the appended claims and their equivalents.

1. A method for producing a glass article comprising:
forming a glass sheet from a molten glass source;
separating the glass article from the glass sheet; and
controlling a water content of an atmosphere surrounding the glass sheet to be below a predetermined value during the step of separating the glass article from the glass sheet.

2. The method of claim 1, wherein, during the step of separating the glass article from the glass sheet, a temperature of the atmosphere surrounding the glass sheet is at least about 35° C. and the water content of the atmosphere surrounding the glass sheet is controlled to be less than 1 wt % based on the total weight of the atmosphere.

3. The method of claim 2, wherein the temperature of the atmosphere surrounding the glass sheet is at least about 50° C.

4. The method of claim 2, wherein the controlling comprises controlling the water content of the atmosphere surrounding the glass sheet to be less than about 0.5 wt % based on the total weight of the atmosphere.

5. The method of claim 1, wherein, during the step of separating the glass article from the glass sheet, the temperature of the glass sheet ranges from about 100° C. to about 500° C.

6. The method of claim 1, further comprising controlling the atmosphere surrounding the glass sheet to be substantially free of water during the step of separating the glass article from the glass sheet.

7. The method of claim 1, further comprising flowing a gas stream over the glass sheet during the step of separating the glass article from the glass sheet, at least 99 wt % of the gas stream comprising at least one gas selected from the group consisting of nitrogen, oxygen, and argon.

8. The method of claim 7 wherein the gas stream comprises nitrogen and oxygen.

9. The method of claim 8, wherein the weight ratio of nitrogen to oxygen in the gas stream ranges from 4:1 to 8:1.

10. The method of claim 7, wherein at least 99 wt % of the gas stream comprises nitrogen.

11. The method of claim 7, wherein at least 99 wt % of the gas stream comprises argon.

12. The method of claim 7, wherein the temperature of the gas stream is at least about 35° C.

13. The method of claim 7, wherein the gas stream comprises less than about 0.1 wt % water.

14. The method of claim 1, further comprising applying a detergent solution to the glass article.

15. The method of claim 14, wherein following application of the detergent solution to the glass article, the density of particles adhered to the glass article is at least 50% less than the density of particles adhered to the glass article in a process that does not comprise controlling the water content of the atmosphere surrounding the glass sheet to be below a predetermined value during the step of separating the glass article from the glass sheet.

16. The method of claim 1, wherein the glass sheet is moving and the step of separating the glass article from the moving glass sheet comprises scoring the moving glass sheet along an intended separation path to form a score line, engaging the moving glass sheet with an engagement assembly and rotating the engagement assembly about an axis substantially coinciding with the score line.

17. The method of claim 1, further comprising flowing a gas stream over the glass sheet during the separating, the gas stream consisting essentially of at least one gas selected from the group consisting of nitrogen, oxygen, and argon.

18. The method of claim 17, wherein the gas stream consists essentially of nitrogen and oxygen.

19. The method of claim 18, wherein a weight ratio of nitrogen to oxygen in the gas stream ranges from 4:1 to 8:1.

20. The method of claim 17, wherein the gas stream consists essentially of nitrogen.

21. The method of claim 17, wherein the gas stream consists essentially of argon.

22. The method of claim 17, wherein a temperature of the gas stream is at least about 35° C.

23. The method of claim 17, wherein the gas stream comprises less than about 0.1 wt % water.
